(19) United States
(12) Patent Application Publication
(10) Pub. No.: US 2014/0318324 A1
(43) Pub. Date: Oct. 30, 2014

(54) INSTALLATION APPARATUS AND SYSTEM FOR CEILING MOUNTED ITEMS

(71) Applicant: ACCELERATED FASTENING LLC, Janesville, WI (US)

(72) Inventors: David J. Buchner, Janesville, WI (US); J. Reed Felton, Wauwatosa, WI (US)

(21) Appl. No.: 14/325,557

(22) Filed: Jul. 8, 2014

Related U.S. Application Data
(63) Continuation-in-part of application No. 12/642,425, filed on Dec. 18, 2009.

(51) Int. Cl. B25F 1/00; B25B 23/00; B23B 47/26; B25G 1/04

(52) U.S. Cl. CPC B25F 1/00; B25G 1/04; B25B 23/0021; B23B 47/26
USPC 81/53.1; 29/270; 408/67

(57) ABSTRACT

An apparatus and system comprises a pole having a top end and a bottom end. The top end is used adjacent a ceiling. The bottom end is used by an installer who is standing on the ground below the ceiling. The present invention is intended to be “modular,” the top and bottom ends being like-configured such that either end can be used as the top end or as the bottom end. Exemplary accessories are shown and described, each of which is disposed in a top end position. There are two types of accessory items contemplated by this invention. First, are fastening tools which are, for the most part, common utilitarian tools used with some sort of specific adapter and/or coupler. Second, there are proprietary accessories, which include offset couplings which can be used to drill and then impact or screw/torque a fastener into an aperture following drilling.

This application is a continuation-in-part of U.S. patent application Ser. No. 12/642,425 filed Dec. 18, 2009.

### FIELD OF THE INVENTION

The present invention relates generally to the field of tools that are used to install or attach items to a ceiling. More specifically, it relates to a ceiling impact and torque applying apparatus that can be used by an installer from a position on a floor below the ceiling and to a system having multiple attachments that can be used with the device in a variety of ways and for a variety of purposes.

### BACKGROUND OF THE INVENTION

To install ceiling mounted items, an installer must typically elevate his or her body in order to access the ceiling. Usually this is accomplished using a ladder, stilts, or scaffolding. Once elevated, the installer drills a hole into the ceiling and then pounds a fastener (e.g., a concrete anchor) into the hole, which generally requires the use of two hands. All of this activity requires the elevation of the user and his or her tools.

This method of installing ceiling mounted items is not desirable because multiple steps are needed to install the ceiling mounted item, namely, inserting a fastener of some sort that requires the use of both hands while balancing (e.g., on a ladder or stilts) and using both hands to pound in the fastener into the ceiling, which necessitates putting down the drill and increases the installation time. Accordingly, it is desirable to have an installation apparatus and system that reduces the number of steps needed to install ceiling mounted items. It is further desirable to have such an installation apparatus that provides a wide variety of functionality so as to be well-utilized in the field. It is further desirable to provide a number of modular and attachable accessory items that can be used with a modular pole to accomplish specific installation tasks or provide for installation of specialized ceiling fasteners and anchors. It is further desirable to have an installation apparatus and system for installing ceiling mounted items that is safer to use than are current methods.

### SUMMARY OF THE INVENTION

The apparatus and system of the present invention comprises a component-based inertia and torque hammer with multiple attachments. The apparatus and system functions by means of a universal coupling system. In a preferred embodiment, the apparatus comprises a solid, round, metal bar or pole with two diameters and a slide tube that slides over the smaller diameter. The slide tube is slotted. The slide tube's travel up and down the pole is limited by a fastener connected to the pole through the slot in the slide tube. The distance the slide tube travels is determined by the length of the slot in the slide tube. A coil spring is captured between the pole's larger diameter and the slide tube, thereby enabling a telescoping action along the pole's axis and forcing the slide tube in one direction for the complete length of the slot in the slide tube. Using this apparatus, an installer can deliver a hammer blow to an item at the level of the ceiling:

Additionally, since the hammer blow applied by the tool is a function of the weight being moved and its speed, i.e. inertia, and then stopped against a fixed object, which is the ceiling, weights can be added to the pole to accommodate varying hammer force requirements of the fastener being installed or to accommodate the preferences of the installer.

A number of modular and attachable accessory items are configured for use with the modular pole to accomplish specific installation tasks or provide for installation of specialized ceiling fasteners and anchors. That is, both ends of the apparatus and system accept various attachments via a standard coupler to allow different functions. The constant upward pressure that the spring provides on the slide tube enables various attachments to be used while a constant vertical pressure from the spring is applied. The apparatus can be used with different length extensions to accommodate varying ceiling heights. The extensions can also be used independently of the slide tube function installation system for ceiling mounted items that is comprised of a tubular hollow extension. The first end of the tubular hollow extension is adapted to receive a suspension member and the second end is adapted to be attached to a drill bit or operated manually. The foregoing and other features of the present invention will be apparent from the detailed description that follows.

### BRIEF DESCRIPTION OF THE DRAWINGS

FIG. 1a illustrates a perspective view of an exemplary embodiment of an extension for an installation system for ceiling mounted items.

FIG. 1b illustrates a perspective view of the first end of an exemplary embodiment of an extension with eyelet member and suspension member.

FIG. 1c illustrates a perspective view of a concrete anchor.

FIG. 2 illustrates a sectional view of an exemplary embodiment of an extension.

FIG. 3 illustrates an exploded view of an exemplary embodiment of a clamp system for securing an extension.

FIG. 4 illustrates a sectional view of an exemplary embodiment of an extension secured using a clamp system.

FIG. 5 illustrates an exemplary embodiment of a hyperextension extension system.

FIG. 6 illustrates two views of the dust shroud accessory in accordance with the present invention, the first view being a side elevational view and the second being a partial sectional view thereof.

FIGS. 7A and 7B illustrate a front elevational view and a top plan view, respectively, of a specific modular accessory that is used to insert and tighten a ceiling anchor.

FIG. 8 illustrates a front elevational view of a clevis hanger accessory that is used in accordance with the present invention.

FIG. 9 illustrates a side and front elevational view of an accessory for a ceiling wedge anchor that is used in accordance with the present invention.

FIG. 10 illustrates a side elevational view of an SDS+ chuck accessory with a female coupling for use in accordance with the present invention.

FIG. 11 illustrates a side elevational view of a hand stapler accessory that is attached to a modular pole with a female coupling for use in accordance with the present invention.

### DETAILED DESCRIPTION

As a preliminary matter, it is understood that the apparatus and system of the present invention is configured in such a way that it is an improvement over the device that is disclosed and claimed in U.S. patent application Ser. No. 12/642,425, and the full text of that application is incorporated herein by reference under the heading “Prior Description.” New matter is introduced under the heading “Current Additional Description.”

### Prior Description

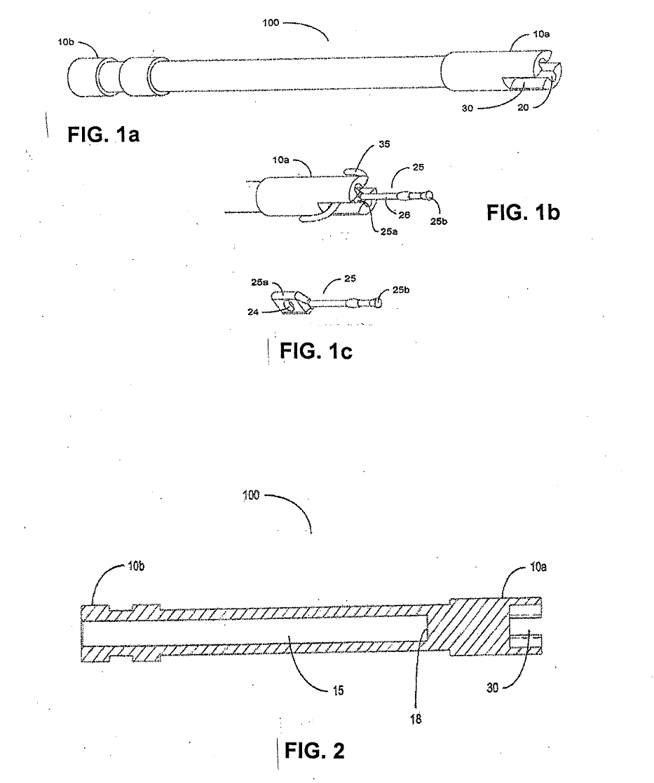

FIG. 1 a illustrates a perspective view of an exemplary embodiment of tubular hollow extension 100 for an installation system for ceiling mounted items. Tubular hollow extension 100 is adapted to be mounted on a drill bit (not shown) and has first end 10a and second end 10b. First end 10a includes eyelet channel 20 adapted to receive an eyelet member (not shown) and suspension member channel 30 adapted to receive a suspension member. Second end 10b is adapted to be attached to a drill bit.

In the embodiment shown, eyelet channel 20 is oval-shaped to accommodate eyelet member 25a (FIG. 1c). In other embodiments, eyelet channel 20 may be circular, square or of another shape which accommodates and steadies eyelet member 25a so that concrete anchor 25 (FIG. 1c) can be installed into a ceiling.

In the embodiment shown, tubular hollow extension 100 is manufactured from stainless steel and is approximately ten inches in length. In other embodiments, tubular hollow extension 100 may be manufactured from a different material and may be shorter or longer. In the embodiment shown, tubular hollow extension 100 has radial variations which reduce the amount of material and the weight of tubular hollow extension 100. It is desirable to reduce weight since a user is holding hollow tubular extension above their head.

FIG. 1b illustrates a perspective view of first end 10a of hollow tubular extension 100 with concrete anchor 25 having eyelet member 25a and boring member 25b inserted into eyelet channel 20. In the embodiment shown, concrete anchor 25 is a wedge (e.g., a tie wire wedge) or pin structure known in the art comprised of eyelet member 25a and boring member 25b. Eyelet member 25a is flattened panel which includes aperture 24 (FIG. 1c), neck 26 and boring member 25b which is capable of penetrating concrete. Threaded through aperture 24 is suspension member 35. Suspension member channel 30 accommodates suspension member 35 when eyelet member 25a is placed inside eyelet channel 20.

In the embodiment shown, suspension member 35 is a wire, but in other embodiments may be a pin, string, chain, cord, rope or another attachment component which can be threaded through aperture 24 in eyelet member 25a. In still other embodiments, eyelet member 25a is a component of a concrete anchor or another type of fastener known in the art.

To install concrete anchor 25 into a ceiling, hollow tubular extension 100 is placed over the end of a drill bit (when drill bit is facing upward) and eyelet member 25a with suspension member 35 is placed in eyelet channel 20 so that suspension member 35 resides in suspension member channel 30. Concrete anchor 25 is then placed against a ceiling and the drill is used to apply pressure to hollow tubular extension 100 and eyelet member 25a so that boring end 25b of concrete anchor 25 is inserted in a predrilled hole in the ceiling. The installer can use one of his or her hands for balance while inserting concrete anchor 25 into the ceiling.

FIG. 1c illustrates concrete anchor 25 having eyelet member 25a, boring member 25b, and aperture 24 into which a securing means (such as wire or a rod) is inserted. Concrete anchor 25 may be a fastening pin, tie wire wedge or other functionally equivalent device known in the art.

FIG. 2 illustrates a sectional view of an exemplary embodiment of tubular hollow extension 100. In the embodiment shown, second end 10b of tubular hollow extension 100 is placed over the end of a drill bit (not shown). The drill bit resides loosely inside hollow channel 15 and the drill bit shaft rests against end 18 of hollow channel 15 preventing tubular hollow extension 100 from contacting the chuck of the drill (not shown). Also visible is suspension member channel 30. In the embodiment shown, suspension member channel 30 is square; however, in other embodiments, may be of another shape and/or size to accommodate a suspension member.

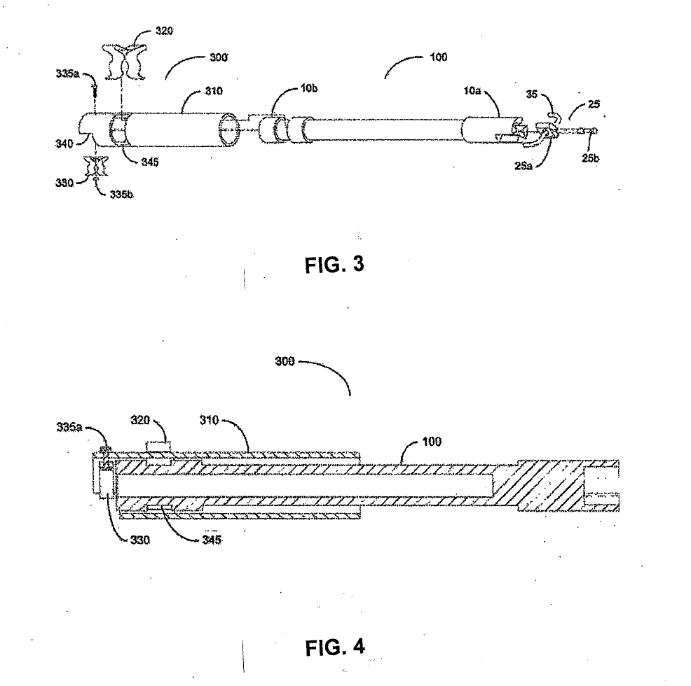

FIG. 3 illustrates an exploded view of an exemplary embodiment of clamp system 300 for securing hollow tubular extension 100 to a drill bit, hollow tubular extension 100, and concrete anchor 25. Without clamp system 300, hollow tubular extension 100 only rests on drill bit and will fall off if the drill is tipped at a downward angle. Clamp system 300 secures hollow tubular extension 100 to the drill bit so that hollow tubular extension 100 will not fall off if the drill is tipped at a downward angle, which allows hollow tubular extension 100 to be used to insert an eyelet member into a floor.

In the embodiment shown, clamp system 300 is comprised of sleeve 310, tubular structure clamp 320, and drill bit clamp 330. In the embodiment shown, sleeve 310 has machined contours 340 and 345 which accommodate drill bit clamp 330 and tubular structure clamp 320 respectively and are adapted to receive tubular hollow extension 100. Drill bit clamp 330 is secured inside sleeve 310 using drill bit clamp screw 335a and nut 335b so that the clamp portion of drill bit clamp 330 faces toward the center of sleeve 310.

Drill bit clamp 330 is clamped to the drill bit (not shown) securing sleeve 310 to the drill bit. Tubular hollow extension 100 is slid inside sleeve 310 so that second end 10b rests against drill bit clamp 330 and the narrower portion of second end 10b lines up with machined contour 345 of sleeve 310 of clamp system 300. Tubular structure clamp 320 is then clamped over machined contour 345 securing tubular hollow extension 100 inside sleeve 310.

In the embodiment shown, sleeve 310, tubular structure clamp 320 and drill bit clamp 330 are manufactured from stainless steel. In other embodiments, they may be manufactured from various other materials. In other embodiments, drill bit clamp 330 and/or tubular structure clamp 320 may be replaced with pins, screws, welded components, a ball bearing system or any other securing means known in the art.

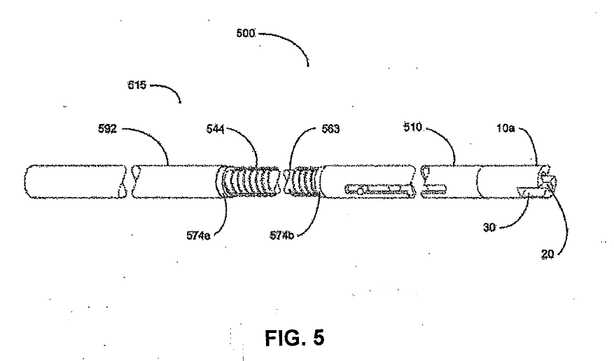

FIG. 4 illustrates a sectional view of an exemplary embodiment of tubular hollow extension 100 secured using clamp system 300. FIG. 5 illustrates an exemplary embodiment of hyperextension tubular hollow extension system 500 which is operated manually, i.e., without a drill. Tubular hollow extension system 500 has two pole components 510, 515. Pole component 515 is comprised of telescoping pole 592 and spring release pole 563. Pole component 510 has a slightly larger diameter than spring release pole 563 which allows it to slide over spring release pole 563. First end 10a of pole component 510 further includes eyelet channel 20 and suspension member channel 30.

Spring release pole 563 has tension springs 544 separated by washers 574a, 574b. Extension system 500 allows an individual to stand on the floor and install a concrete anchor into a ceiling without the use of a ladder, stilts, scaffolding or another elevation means. When pole components 510 and 515 are compressed and released, it creates a force which drives concrete anchor 25 (not shown) in a pre-drilled hole in the ceiling without the need for a hammer.

### Additional Description

As alluded to above, the apparatus and system of the prior and present invention comprises a ceiling hammer, which is a component-based inertia hammer having multiple attachments. The apparatus and system functions by means of a universal coupling system. In a preferred embodiment, the apparatus comprises a solid, round, metal bar or pole with two diameters and a slide tube that slides over the smaller diameter. The slide tube is slotted. The slide tube's travel up and down the pole is limited by a fastener connected to the pole through the slot in the slide tube. The distance the slide tube travels is determined by the length of the slot in the slide tube. A coil spring is captured between the pole's larger diameter and the slide tube, thereby enabling a telescoping action along the pole's axis and forcing the slide tube in one direction for the complete length of the slot in the slide tube. Using this apparatus, an installer can deliver a hammer blow to an item at the level of the ceiling. Since the hammer blow applied is a function of the weight being moved and its speed, i.e. inertia, and then stopped against a fixed object, which is the ceiling, weights can be added to the pole to accommodate varying hammer force requirements of the fastener being installed or to accommodate the preferences of the installer.

Both ends of the apparatus and system accept various attachments via a standard coupler to allow different functions. The constant pressure that the spring provides on the slide tube enables various attachments to be used while a constant vertical pressure from the spring is applied. The apparatus can be used with different length extensions to accommodate varying ceiling heights. The extensions can also be used independently of the slide tube function installation system for ceiling mounted items that is comprised of a tubular hollow extension. The first end of the tubular hollow extension is adapted to receive a suspension member and the second end is adapted to be attached to a drill bit or operated manually.

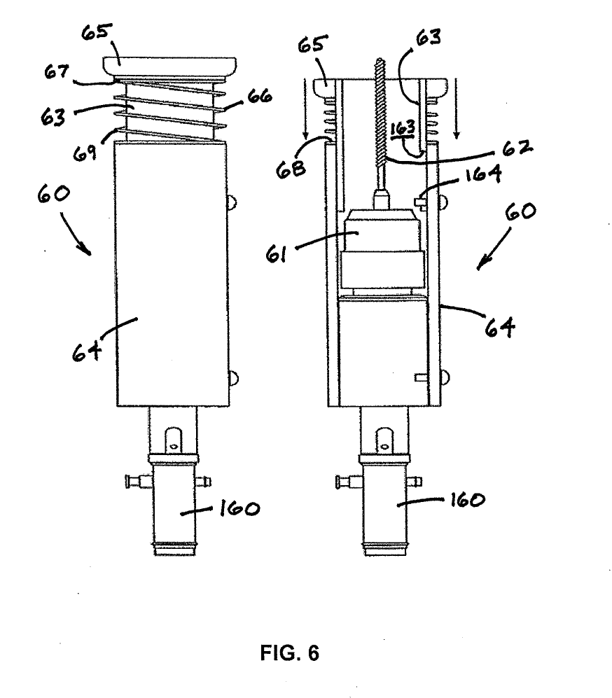

The apparatus and system of the present invention comprises the pole structure mentioned above, the pole structure having a top end and a bottom end. The top end is intended to be used adjacent the ceiling, as described above. The bottom end is intended to be used by the installer who is standing on the ground below the ceiling. However, and in accordance with the present invention, the present invention is intended to be “modular.” That is, the top end and the bottom end are like-configured such that either end can be used as the top end or as the bottom end. Exemplary modular ends are shown in FIGS. 6 through 11, each of which is disposed in a top end position, together with an accessory item. There are two types of accessory items contemplated by this invention. First, are fastening tools which are, for the most part, common utilitarian tools used with some sort of specific adapter and/or coupler. Second, there are proprietary accessories, which include offset couplings (which can be used to drill and then impact or screw/torque a fastener into an aperture following drilling). Further, two key proprietary accessories that will be described in more detail herein are (i) a dust shroud and (ii) an accessory that allows for single handed installation of a SAMMYS® or SAMMY X-PRESS® metal threaded anchor (SAMMYS and SAMMY X-PRESS are registered marks of Illinois Tool Works Inc.). Other accessories will be identified as well.

Referring now to FIG. 6, it shows a dust shroud, generally identified 60. The dust shroud 60 comprises a centrally-disposed drill chuck 61, the chuck 61 being configured to hold a drill bit 62 in conventional means. An outer sleeve 64 is provided and within which the chuck 61 and bit 62 are allowed to rotate. A dust shroud inner sleeve 63 is also provided, the inner sleeve 63 comprising a bearing 65 and the bearing 65 being secured to the inner sleeve 63 of the dust shroud 60. The bearing 65 captures one end 67 of a spring 66 and the second end 6g of the spring 66 rests on an upper margin 68 of the outer sleeve 64. As the dust shroud 60 is urged upwardly by a user, the dust shroud 60 being secured to an upper modular end 160 of a pole structure, the bearing 65 is urged downwardly, compressing the spring 66 and allowing the drill bit 62 to penetrate a ceiling or other surface (not shown) to create a cylindrical hole (also not shown) in that surface. During the drilling process, any dust that is created by drilling of the hole is captured within the dust shroud 60. When the drilling is completed, the dust shroud 60 can be removed from the modular pole end or coupling 160 and any accumulated dust can be emptied from the shroud 60. The dust shroud 60 can be reattached to continue with additional drilling or be swapped out for another accessory item that can be used to insert an anchor into the hole, for example. It is also to be appreciated that the shroud 60 can comprise a depth-limiting function via use of a slot (not shown) that is defined within a side wall of the inner sleeve, the slot having a margin 163 at its upper end. A stop structure 164 is provided within the outer sleeve 64 such that the depth of the hold that is drilled by the bit 62 can be controlled by the user as desired or required.

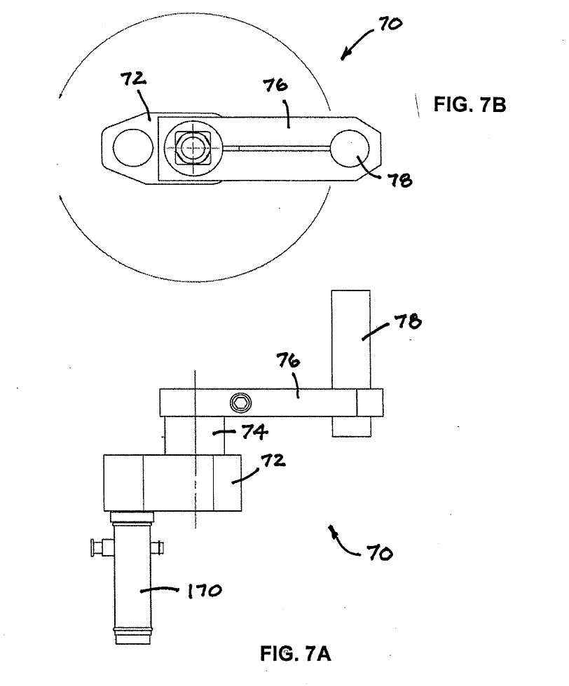

Referring now to FIGS. 7A and 7B, they illustrate an assembly, generally identified 70, for securing a SAMMYS® or SAMMY X-PRESS® metal threaded anchor (not shown) within an aperture. It is to be understood that the SAMMY X-PRESS® anchor (or simply, the “anchor” as that term is used herein) is made to facilitate installations through corrugated metal ceiling decks, such decks typically comprising a clipped wave-like structure having flat bottom surfaces and adjacent flat top surfaces between which are connecting angled surfaces (also not shown). The anchor itself comprises two components—a male threaded hex head bolt with integral male screw threads and female threads in the hex bolt aligned axially to the male threads and elongated threaded protuberance of the second component, which is a collapsible round, female threaded, elongated and slitted protuberance integral to a square base with a receiving female threaded aperture mating to the male threads on the hex bolt of the first component. When installed, a hole is drilled through the metal deck and the elongated protuberance is inserted through the hole. The hex bolt is tightened by clockwise rotation while the square base is held stationary. The continued tightening action of the hex bolt and integral male screw thread upon the internally-threaded protuberance uniformly collapses the slitted protuberance thereby pressing those portions of the protuberance upon the metal deck and capturing the deck between the collapsed protuberance and the square base. Heretofore, a special installation tool is provided by the manufacturer of the SAMMYS® or SAMMY X-PRESS® metal threaded anchor which requires that the installer use one hand to operate the drill and the other hand to hold the handle of the installation tool, which is a SAMMY X-PRESS IT® installation tool (SAMMY X-PRESS IT is a registered mark of Illinois Tool Works Inc.). The accessory of the present invention can be used to insert and secure the anchor by using the accessory at the end of the modular pole, thereby eliminating the need for the installer to be within hands' reach of the anchor.

The anchor securing assembly 70 is attachable to a modular pole end or coupling 170 configured as previously described. The assembly 70 generally comprises a hex driver assembly 72, a hex driver housing 74, a stationary arm sub-assembly 76 and a vertically adjustable stop 78. Again, see FIGS. 7A and 7B. The modular pole end or coupling 170 can be used to rotationally drive the anchor securing assembly 70. The rotational action of the coupling 170 drives the hex driver 72 and, in turn, the hex head bolt (not shown). While the hex driver 72 rotates freely within the hex driver housing 74, it tightens and collapses the protuberance of the anchor (also not shown). During this rotation, the adjustable stop 78 held within the stationary arm sub-assembly 76 engages a portion of the sheet metal roofing deck (not shown) to restrict movement of the stop 78 and sub-assembly 76 thereby allowing the anchor to be installed via the rotational force of the hex driver 72 to successfully collapse and tighten the protuberance of the anchor. In this fashion, the anchor securing assembly 70 can be used at the end of a modular pole that is equipped with the coupling 170 and eliminates the need for the installer to have both hands in close proximity to the anchor and ceiling during normal installation as intended by the anchor manufacturer.

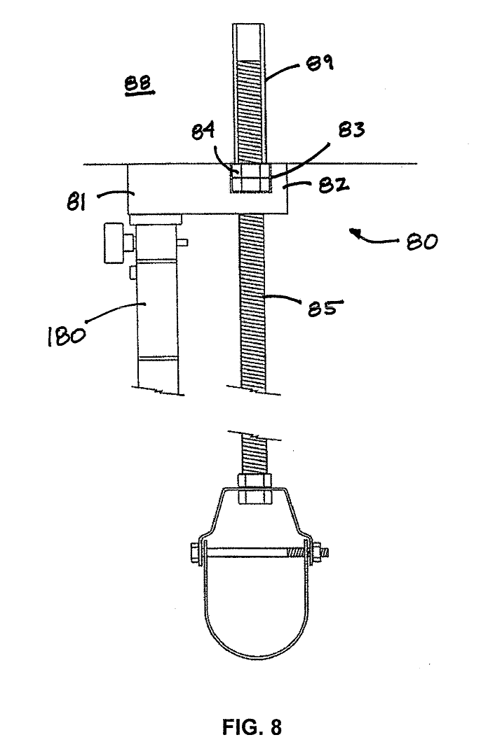

Referring now to FIG. 8, it comprises a similar modular coupling 180 and a universal securing assembly 80. As shown, the assembly 80 comprises a first end 81 that is attached to the coupling 180 and a second end 82. The second end 82 comprises an aperture 83 for holding a nut 84 of a fastener 85, which is a clevis hanger. Prior to installation, a hole 89 is drilled into the ceiling 88. The threaded end 86 of the fastener 85 is then rotated, together with the assembly 80 and the coupling 180 to tighten the fastener 85 within the hole 89. This action can be repeated for multiple holes 89.

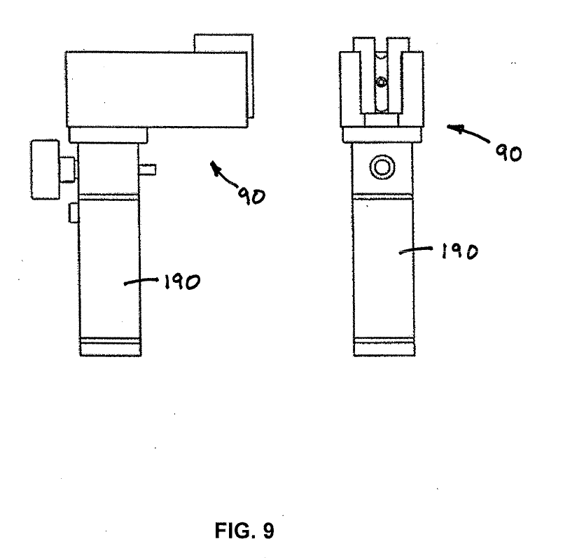

Referring now to FIG. 9, it illustrates two views of a ceiling wedge anchor assembly, generally identified 90, which is similarly removably attached to a modular coupling 190.

In each of the foregoing examples, it is to be understood that the installer first uses a drill or other torqueing instrument that is or can be secured to the bottom end of the modular pole structure. The top end is intended to receive any number of accessories that can be inserted into or attached to a ceiling. The top end can include a holding structure, which holding structure can be axially-aligned with the pole structure or offset from it. See FIGS. 8 and 9, for example. It is to be understood that the present invention has a wide variety of applications. Among other things, the apparatus and system of the present invention can be used to fasten wood lag screws into wood joists from the floor with an electric drill attached to the ceiling hammer. These lag screws typically have an eyelet through which a wire can be pre-fastened before the lag screw is installed.

The apparatus and system of the present invention can also be used to fasten self-drilling metal deck screws into steel, such as I-beams, purlins, steel joists, etc., for the purpose of hanging a wire, which can be pre-fastened before the deck screw is installed.

The apparatus and system of the present invention can also be used to fasten caddy fastener clips to purlin beams through attaching the daddy fastener installation tool to the ceiling hammer.

The apparatus and system of the present invention can also be used to install pre-tied ceiling wires on wedge anchors into pre-drilled concrete holes in a ceiling.

The apparatus and system of the present invention can also be used to enable the positioning of a Powers “Sniper” powder actuated gun (or similar powder actuated gun) to the ceiling for shooting a pre-tied ceiling wire clip into concrete ceilings.

The apparatus and system of the present invention can also be used to facilitate the positioning and twisting of wires around a bar joist with a wire twisting attachment that lifts the ceiling tie-wire up, over and around a bar joist. It can then be used to twist the wire on itself to secure it around the joist.

The apparatus and system of the present invention has the capacity to accept a variety of drill chucks for holding multiple different tool attachments such as a sleeve which holds a drywall screw, a large drill bit for drilling holes into wire mesh or for toggle bolts, among other things. The apparatus and system of the present invention can also be attached to a standard drill or hammer-drill for screwing, tightening, or hammering in various fasteners.

The apparatus and system of the present invention includes a handle to provide for an easy grip at the bottom of the ceiling hammer.

With the attachment of a hammer-drill, the apparatus and system of the present invention also has the capacity to drill holes in concrete ceilings. The drill is positioned at the bottom of the extension pole which is unique.

The apparatus and system of the present invention can also be used with a socket head attachment. Various ceiling anchors that attach to concrete, steel or wood ceilings require that they be attached by applying a wrench to a hex head nut to be tightened. With either a ratchet wrench attachment or attached drill, hex head fasteners can be tightened and torqued to a specified torque setting.

The apparatus and system of the present invention can also be used to drop anchors into concrete. Then, by changing out the tip, it can install the threaded rod into the drop in anchor.

The apparatus and system of the present invention can also be used to install Trubolt anchors into concrete ceilings or, by changing the head, can install a completed threaded rod assembly into the installed Trubolt or similar internally threaded anchor.

The apparatus and system of the present invention can also be used to install various hex head fasteners and threaded rod anchoring systems into wood, steel, and concrete. This could be the fastener only, and/or the fastener with a completed threaded rod assembly.

The apparatus and system of the present invention can also be used to install J-hook or similar assemblies into wood, steel, or concrete ceilings.

The apparatus and system of the present invention can also be used to receive a drill, cordless or wired, or hammer drill for drilling, screwing, hammering, or tightening an anchor.

The apparatus and system of the present invention has a live handle with an optional captured ratchet wrench and a standard square drive socket drive attachment (male and female) for tightening anchors, bolts, nuts, hex head fasteners, or fasteners of other head configurations.

The apparatus and system of the present invention also accepts a Powers Sniper gun or other powder actuated tools for shooting fasteners into concrete.

The apparatus and system of the present invention also accepts collated screw guns for screwing and fastening into ceilings.

The apparatus and system of the present invention also accepts a universal drill saddle to create a drill extension for drilling in to or hammering into ceilings.

The apparatus and system of the present invention also acts as a drill extension to drill holes into concrete ceilings.

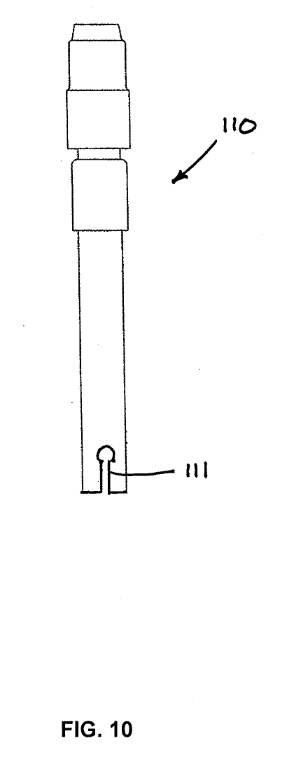

Referring now to FIG. 10, it illustrates an SDS+ chuck, generally identified 110. The modular coupling is not illustrated for this embodiment, although the chuck 110 comprises a slot 111 for accomplishing such attachment. The apparatus and system of the present invention accepts a standard chuck and an SDS+ chuck for holding multiple tool attachments such as SDS+ bits, a sleeve which holds a drywall screw, a large drill bit for drilling holes, a spade bit, a chisel, etc. (not shown).

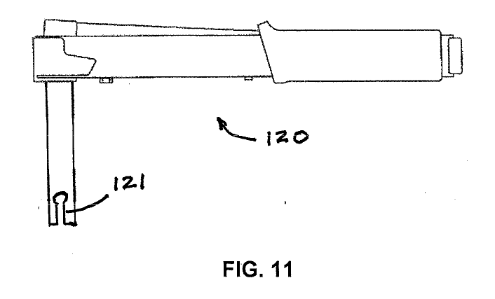

Referring now to FIG. 11, it illustrates a hand stapler accessory that is also not attached to the modular pole, the stapler accessory being generally identified 120. Although the modular coupling is not illustrated for this embodiment, it will be seen that the chuck 110 comprises a slot 111 for accomplishing such attachment. The apparatus and system of the present invention can also be used to accept a standard commercial stapler allowing staples to be installed in overhead applications.

Virtually any hand fastened fastener device, stapler, nailer, screws, etc. can be accommodated for installation with the ceiling hammer of the present invention.

The details of the invention having been disclosed in accordance with the foregoing, we claim:

1. A modular accessory that is attachable to a pole, the pole having a top and a bottom, the modular accessory being configured for mounting fasteners into a ceiling.

2. The modular accessory of claim 1 wherein the modular accessory comprises an offset coupling.

3. The modular accessory of claim 2 comprising structure for drilling a hole and then inserting a fastener into the hole by applying a torque force to the pole.

4. The modular accessory of claim 1 comprising an SDS+ chuck.

5. The modular accessory of claim 1 comprising a dust shroud.

6. The modular accessory of claim 5 wherein the dust shroud comprises:
a modular coupling;
a drill chuck and drill bit for drilling a hole in a ceiling surface;
an outer sleeve and an inner sleeve, the inner sleeve being slidable within the outer sleeve, the inner sleeve comprising a bearing and the outer sleeve comprising an upper margin; and
a spring disposed between the bearing of the inner sleeve and the margin of the outer sleeve;
wherein the bearing is urged downwardly to expose the drill bit to the ceiling surface during use.

7. The modular accessory of claim 3 comprising structure for setting an anchor into a metal roof structure, the anchor comprising a hex head and a collapsible protuberance, the accessory structure comprising:
a modular coupling;
a hex driver assembly;
a hex driver housing;
a stationary arm sub-assembly; and
an adjustable stop;
wherein rotation of the coupling drives the hex driver and the hex head of the anchor to collapse the protuberance and secure the anchor to the metal roof structure.

8. The modular accessory of claim 3 comprising structure for anchoring a clevis hanger to a ceiling.

9. The modular accessory of claim 3 comprising structure for mounting a stapler to the pole.

10. A modular system comprising a pole and an accessory that is attachable to the pole, the pole having a top and a bottom, the modular accessory being configured for mounting fasteners into a ceiling.

11. The modular system of claim 10 wherein the modular accessory comprises an offset coupling.

12. The modular system of claim 11 comprising structure for drilling a hole and then inserting a fastener into the hole by applying a torque force to the pole.

13. The modular system of claim 10 comprising an SDS+chuck.

14. The modular system of claim 10 comprising a dust shroud.

15. The modular system of claim 14 wherein the dust shroud comprises:
a modular coupling;
a drill chuck and drill bit for drilling a hole in a ceiling surface;
an outer sleeve and an inner sleeve, the inner sleeve being slidable within the outer sleeve, the inner sleeve comprising a bearing and the outer sleeve comprising an upper margin; and
a spring disposed between the bearing of the inner sleeve and the margin of the outer sleeve;
wherein the bearing is urged downwardly to expose the drill bit to the ceiling surface during use.

16. The modular system of claim 12 comprising structure for setting an anchor into a metal roof structure, the anchor comprising a hex head and a collapsible protuberance, the accessory structure comprising:
a modular coupling;
a hex driver assembly;
a hex driver housing;
a stationary arm sub-assembly; and
an adjustable stop;
wherein rotation of the coupling drives the hex driver and the hex head of the anchor to collapse the protuberance and secure the anchor to the metal roof structure.

17. The modular system of claim 12 comprising structure for anchoring a clevis hanger to a ceiling.

18. The modular system of claim 12 comprising structure for mounting a stapler to the pole.
